(19) United States
(12) Patent Application Publication
(10) Pub. No.: US 2017/0101871 A1
(43) Pub. Date: Apr. 13, 2017

(54) BLADE FOR FLUID FLOW MACHINE, TURBO FAN ENGINE AND METHOD FOR MANUFACTURING A BLADE

(71) Applicant: Rolls-Royce Deutschland Ltd & Co KG, Blankenfelde-Mahlow (DE)

(72) Inventors: Christian TIEDEMANN, Berlin (DE); Carsten ALLNOCH, Berlin (DE)

(21) Appl. No.: 15/288,074

(22) Filed: Oct. 7, 2016

(30) Foreign Application Priority Data
Oct. 8, 2015 (DE) 10 2015 219 530.9

(51) Int. Cl. F01D 5/18; F01D 9/06; F01D 9/04

(52) U.S. Cl. CPC F01D 5/186; F01D 9/041; F01D 9/065; F05D 2240/306; F05D 2240/304; F05D 2240/305; F05D 2230/30; F05D 2260/202

(57) ABSTRACT

A blade/vane for a turbomachine that has a blade/vane outer skin and a blade/vane internal structure is provided. The blade/vane internal structure has a plurality of elongated support elements that extend obliquely to the radial direction of the blade/vane at least in certain sections, wherein the support elements are connected to each other and/or to the blade/vane outer skin, and the areas between the support elements are configured as hollow spaces.

### REFERENCE TO RELATED APPLICATION

This application claims priority to German Patent Application No. 10 2015 219 530.9 filed on Oct. 8, 2015, the entirety of which is incorporated by reference herein.

### BACKGROUND

The invention relates to a blade/vane for a turbomachine, a turbofan engine and a method for manufacturing a blade/vane.

It is known to design blades/vanes of a turbomachine as hollow blade/vanes that comprise a structured blade/vane interior space with hollow structures.

Thus, EP 2 584 146 A1 describes a rotor blade for a turbomachine that has a blade interior space that is structured by wall-like cross webs. It is provided in exemplary embodiments that such wall-like cross webs cross each other or run back and forth between the suction side and the pressure side of the blade, with triangular or square-shaped hollow structures being created in the cross section. At that, the individual hollow structures extend continuously in the radial direction from the blade root to the blade tip.

EP 1 995 411 A2 describes a rotor blade that has separating walls which extend back and forth between the suction side and the pressure side of the blade, thus forming triangular hollow spaces in the cross section. In another exemplary embodiment, square hollow spaces are formed. Here, too, it is provided that the hollow spaces continuously extend in the radial direction from the blade root to the blade tip.

### SUMMARY

There is the need of further optimizing the blades/vanes for a turbo-machine regarding their weight and integrity.

There is the objective to provide a blade/vane for a turbo-machine that is characterized by a low weight while at the same time being very strong and having a high degree of integrity. What is further to be provided is a method for manufacturing such a blade/vane.

This objective is achieved through a blade/vane with features as described herein, a turbofan engine as described herein, and a method for manufacturing a blade/vane with features as described herein.

According to that, the solution is characterized by having a blade/vane internal structure which comprises a plurality of elongated support elements that extend obliquely to the radial direction of the blade/vane at least in certain sections (i.e., along their entire length, or along at least one section). The support elements are connected to each other and/or to the blade/vane outer skin. The areas between the support elements are configured as hollow spaces.

The solution is characterized by the provision of a blade/vane internal structure that is not formed by straight or linear walls or webs, but instead consists at least in part of support elements that extend obliquely and vary in their thickness. At that, the support elements may form an irregular and asymmetrical three-dimensional grid. The fact that the support elements extend obliquely to the radial direction of the blade/vane at least in certain sections means that, among other things, the support elements are not configured to be continuous in the radial direction of the blade/vane, i.e., they do not extend continuously in the radial direction between blade/vane root and blade/vane tip. Due to the oblique alignment, it is further facilitated that the support elements are connected to each other so as to form a three-dimensional asymmetrical grid. The described solution makes it possible to configure the shape and the spatial course of the support elements in a manner that matches the stress requirements, i.e., to provide the support elements in those areas of the blade/vane interior, in which high mechanical loads are present during operation of the blade/vane. The support structure that is configured in a spatially free manner is not a planar framework, but instead all spatial angles are made use of.

In this way, it will be possible to economize material usage or to provide a high share of hollow space with achieving a high degree of strength and structural integrity of the blade/vane that is described herein at the same time.

In one embodiment, the support elements have a cross-sectional surface that changes along its spatial course. The fact that the support elements have cross-sectional surfaces that vary along their spatial course means, among other things, that the shape and/or the circumference of the cross-sectional surfaces of the support elements varies along the elongated spatial course of the support elements. For example, tapers or bulges may be realized.

According to one design variant, the support elements have a curved spatial course at least in certain sections. Among other things, this means that at least some of the support elements extend in a curved manner at least in certain sections. Thus, the support elements are not configured to be straight or linear, but extend in a curved manner at least in partial areas.

According to another design variant, the support elements are configured in a rib-like manner at least in certain sections. The used rib-like support elements have an oval shape in the cross section, i.e., the circumference of the cross-sectional surface is formed by a closed curve that is smooth and convex.

According to another embodiment, the support elements at least in certain sections form a web that extends between the suction side and the pressure side of the blade/vane. Thus, the support elements can also form wall areas. However, in contrast to planar walls, these wall areas extend obliquely to the radial direction of the blade/vane at least in certain sections and have a cross-sectional surface that varies along its spatial course.

Further, it can be provided that at least two of the support elements are united to form one support element in a branching area. It can also be provided that one support element is divided into two support elements in a branching area. This includes one support element branching off from another support element. In this manner, cross-linkages between the individual support elements are facilitated, in total providing an irregular and asymmetrical three-dimensional grid of support elements.

In such a branching area, between 3 and 100, in particular between 3 and 50, quite particularly between 3 and 10 support elements can come together, for example.

In one embodiment, between 0.1 and 5, in particular between 0.1 and 3, quite particularly between 0.1 and 0.5 connection areas per mm running length of the support elements are arranged along the support elements.

In an additional or alternative embodiment, the running direction of the support elements is measured as the shortest path from the leading edge of the blade/vane to the trailing edge of the blade/vane, or as the shortest path from the suction side to the pressure side of the blade/vane.

In one embodiment, the medium share of the hollow space in the blade/vane internal structure is between 65 and 80%, in particular between 65 and 75%, quite particularly 70%. This mean value is to be determined along a slice plane along the center line of the blade/vane.

In another design variant, it is provided that multiple support elements are united at least in certain sections to form planar support structures. For example, it can be provided that multiple support elements end in a planar or plate-like structural area, or that they extend starting from such an area. Thus, in particular between 3 and 100, in particular between 3 and 50, quite particularly between 3 and 10 support elements can be united at least in certain sections to form planar wall areas.

Alternatively or additionally, it is possible that the support elements form an irregular and asymmetrical three-dimensional grid.

It is provided in another design variant that the support elements form a plurality of hollow spaces. These hollow spaces can be configured in a closed manner, i.e., they are completely surrounded by the material of the support elements. However, alternatively they can also be configured so as to be at least partially open, i.e., they are delimitated by support elements while at the same time being connected to other hollow spaces. In both cases it is provided that the individual hollow spaces have different shapes and sizes, and that they are not uniform with respect to their shapes and sizes.

Particularly in one design variant it is provided that the hollow spaces have a variance with respect to the cross sections of the hollow spaces, as viewed in a sectional view of the blade/vane. What is considered to be the diameter of the hollow spaces here is the greatest distance between two points on a curve which forms the edge of the hollow space in the regarded section. Here, it is provided that at least two of the hollow spaces differ from each other with respect to the cross section thus defined by at least the factor 5. In further design variants, it can be provided that at least two of the hollow spaces differ with respect to the mentioned cross section by at least the factor 10, by at least the factor 20 or by at least the factor 50. Thus, the solution according to this design variant provides hollow spaces inside the blade/vane with strongly differing cross sections or sizes.

In an advantageous design variant, the hollow spaces are delimitated by a smooth and convex limiting curve in the regarded sectional view of the blade/vane. Accordingly, the delimitation of the hollow spaces is formed by an oval in the regarded sectional view.

The mentioned sectional view, in which the hollow spaces comprise the mentioned cross sections of different sizes, can be a sectional view perpendicular to the radial extension direction of the blade/vane, a sectional view perpendicular to the axial extension direction of the blade/vane, or a sectional view perpendicular to the circumferential direction of the blade/vane. Here, it can also be provided that the hollow spaces have the mentioned cross sections of different sizes at least in two sectional views of the blade/vane that are positioned perpendicular to each other.

It is to be understood that the blade/vane described herein may be a rotor blade or a stator vane of a compressor or a turbine. An exemplary application of the invention is an implementation of blade/vanes in a turbofan engine, for example in a fan or in a rotor stage or a stator stage of a compressor or a turbine. However, it is also possible that the blade/vanes are arranged in a stationary turbomachine, such as for example a gas turbine.

As has already been mentioned, an irregular and asymmetrical three-dimensional grid of support elements may be created due to the shape of the support structures. Here, it is provided in one design variant that there are no two support elements of the blade/vane that have an identical three-dimensional shape, i.e., that have the same shape and the same spatial orientation.

It is provided in another embodiment that the share of hollow spaces in the total volume of the blade/vane internal structure increases in the radial direction outwards, which corresponds to a decrease in thickness or in circumference and/or in the number of support elements in the radial direction outwards. This is advantageous insofar as in particular in rotor blades/vanes the radially outer areas of the blade/vane are subject to stronger mechanical loads, and accordingly a reduction in material is particularly advantageous in the radially outer area of a blade/vane.

Just like the directions “axial” and “in the circumferential direction”, here the direction “radial” refers to a blade/vane that is arranged inside a turbomachine, with cylindrical coordinates being regarded and the axial direction being equal or substantially equal to the axis of the turbomachine.

It is provided in another design variant that at least some of the hollow spaces are configured in an elongated manner and are suited for transporting cooling air. Here, it can be provided that at least some of the hollow spaces form cooling openings in the blade/vane outer skin. In this way, it is for example possible to use cooling air introduced through the blade/vane root for cooling the blade/vane, and if necessary to discharge it via the mentioned cooling openings inside the blade/vane outer skin. Thus, the option of cooling becomes available not only for turbine blade/vanes, but also for compressor blade/vanes.

It is provided in another design variant that, due to the grid-shaped structure of the blade/vane internal structure, the interior space of the blade/vane can be filled with cooling air as a whole, i.e., the cooling air is guided into all or into a plurality of the hollow spaces that are connected to each other in this design variant.

The blade/vane that is regarded here is constructed in the conventional manner with respect to the blade/vane outer skin. It particularly has a leading edge, a trailing edge, a suction side, a pressure side, a blade/vane root for fixating the blade/vane, and a blade/vane tip. Instead of a blade/vane root, also another integral fixing element may be provided.

The blade/vane that is described herein can be manufactured my means of a generative manufacturing method, such as for example 3D printing. At that, an exemplary method for manufacturing a blade/vane comprises the following steps:
creating a solid material model of the blade/vane,
iteratively removing material areas of the solid material model based on a finite elements method, wherein during each iteration at least one material area of the solid material model is removed that would be subject to a minor load during operation of the blade/vane in a turbomachine, wherein the iterative method is performed until a defined condition is obtained,
creating a 3D blueprint of the model, which has been made available through the iterative method by the time the defined condition has been reached, and
manufacturing a blade/vane based on the created 3D blueprint by means of a generative manufacturing method (e.g., 3D printing or “direct laser deposition”).

As has already been mentioned, in the course of the iterative removal of material areas of the solid material model based on a finite elements method, at least one such material area of the solid material model is removed during every iteration that would be subject to a minor load during operation of the blade/vane in a turbomachine. According to one design variant, such material areas are removed during every iteration that would be subject to the lowest load during operation of the blade/vane in a turbomachine.

Further, it can be provided that the mentioned method is further specified as follows:
subsequently to the creation of the solid material model, a cross-linkage of the solid material model with a defined resolution is provided,
starting conditions are determined as part of a first iteration process,
as part of a second iteration process:
   material areas of any shape and size are removed at different positions in the solid material model according to the starting conditions,
   loads of the modified model are determined during operation,
   a comparison of the resulting loads with valid acceptance criteria is carried out,
   if the acceptance criteria are met, a further removal of material and the start of a new iteration using the modified model is carried out,
   if the acceptance criteria are not met, the model of the last iteration that met these criteria is used, and the second iteration process is terminated,
as part of the first iteration process, a modification or specification of new starting conditions for a repeated second iteration process is carried out,
a comparison of the results of at least two different second iteration processes is carried out,
the first iteration process is terminated if pre-determined conditions are obtained and/or no further enhancement of the results with respect to the acceptance criteria takes place, and
a 3D blueprint is created for the model that is provided at the end of the second iteration process.

Further, the invention relates to any blade/vane that is manufactured according to the mentioned method.

### BRIEF DESCRIPTION OF THE DRAWINGS

The invention is explained in more detail in the following by referring to the Figures of the drawings based on multiple exemplary embodiments.

FIG. 1 shows an exemplary embodiment of a blade/vane, wherein a first profile section in a first radial height and a second profile section in a second radial height of the blade/vane are shown.

FIG. 1A shows an explanation of details of FIG. 1.

FIG. 2 shows a sectional view of the blade/vane of FIG. 1 along the line A-A of FIG. 1.

FIG. 3 shows a further exemplary embodiment of a blade/vane, with a schematized 3D rendering of the blade/vane interior space being shown.

### DETAILED DESCRIPTION

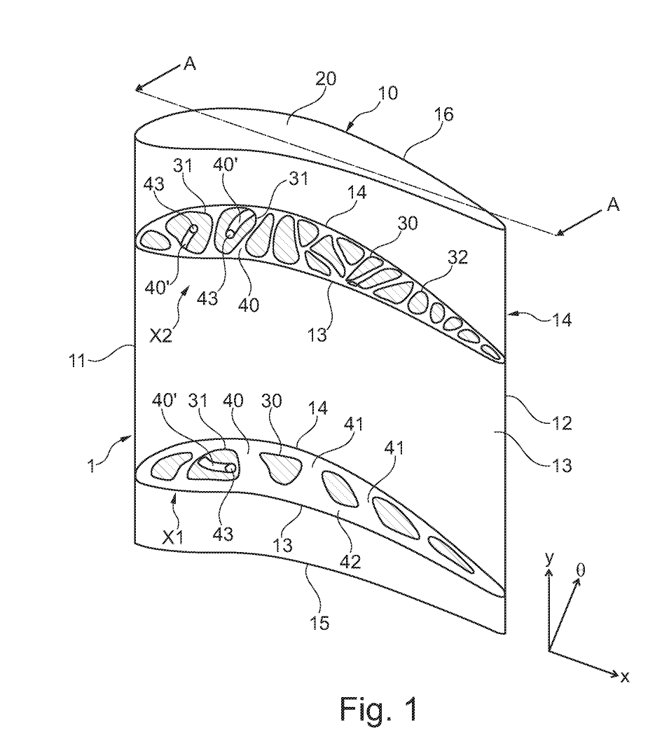

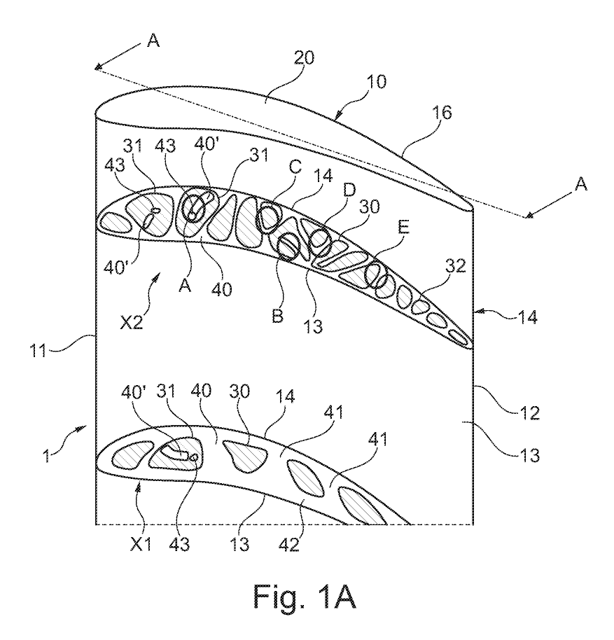

FIG. 1 shows a blade/vane 1 of a turbomachine, which can for example be a turbofan engine for an aircraft. The schematically shown blade/vane 1 can for example be a fan blade/vane, a rotor blade/vane or a stator blade/vane of a compressor, or a rotor blade/vane or a stator blade/vane of a turbine. However, the use of the blade/vanes that are described herein is not limited to aircraft engines. They can also be used in stationary turbomachines.

The blade/vane 1 comprises a blade/vane outer skin 10 and a blade/vane internal structure 20. The blade/vane outer skin 10 comprises a leading edge 11, a trailing edge 12, a pressure side 13 and a suction side 14. The blade/vane internal structure 20 comprises support elements 40 and hollow spaces 30-32.

Each point on the blade/vane outer skin 10 and the blade/vane internal structure 20 can be represented in a cylindrical coordinate system that has the coordinates x, r and θ. Here, x indicates the axial direction, r indicates the radial direction, and θ (out from the drawing plane) indicates the angle in the circumferential direction. The origin of ordinates can for example be defined in such a manner that the x-axis is identical to the rotational axis of the blade/vane 1. Starting from this x-axis, the radial direction is directed radially outward. Here, the value of r indicates the height of the blade/vane 1.

The blade/vane 1 extends in the radial direction between a blade/vane root 15 and a blade/vane tip 16. At that, the blade/vane root 15 is shown only schematically as the lower edge of the blade/vane leaf. In its root area, the blade/vane typically comprises an integral fixing element for fixing the blade/vane, for example at a rotating disc. Principally, the blade/vane can also be configured in one piece with such a disc in BLISK design or in BLING design. The blade/vane tip 16 may be provided with a cover band (not shown).

Multiple blade/vanes of the shown kind form a blade/vane row of a rotor or of a stator.

FIG. 1 shows two profile sections X1, X2 of the blade/vane 1 in two different radial heights, wherein the profile sections extend perpendicular to the radial direction r of the blade/vane.

The blade/vane 1 is characterized by a blade/vane internal structure that has a plurality of elongated support elements 40. The support elements 40 are connected to each other and/or to the blade/vane outer skin 10 and form an irregular and asymmetrical three-dimensional grid that fills the blade/vane interior space 20. The areas between the support elements 40 are configured as hollow spaces 30-32.

The support elements 40 do not extend in a straight or linear manner, they are not planar walls or webs, and do not extend continuously in the radial direction between the blade/vane root 15 and the blade/vane tip 16. Instead, they are support elements with cross-sectional surfaces that vary along their spatial courses, and accordingly change with respect to their thickness or circumference along their longitudinal direction. At the same time, they extend obliquely to the radial direction r of the blade/vane 1 at least in certain sections, which in total results in a grid structure.

The support elements 40 can also be referred to as rib-like elements. They can have a curved spatial course at least in certain sections, i.e., they can be configured in a curved manner with respect to their longitudinal direction.

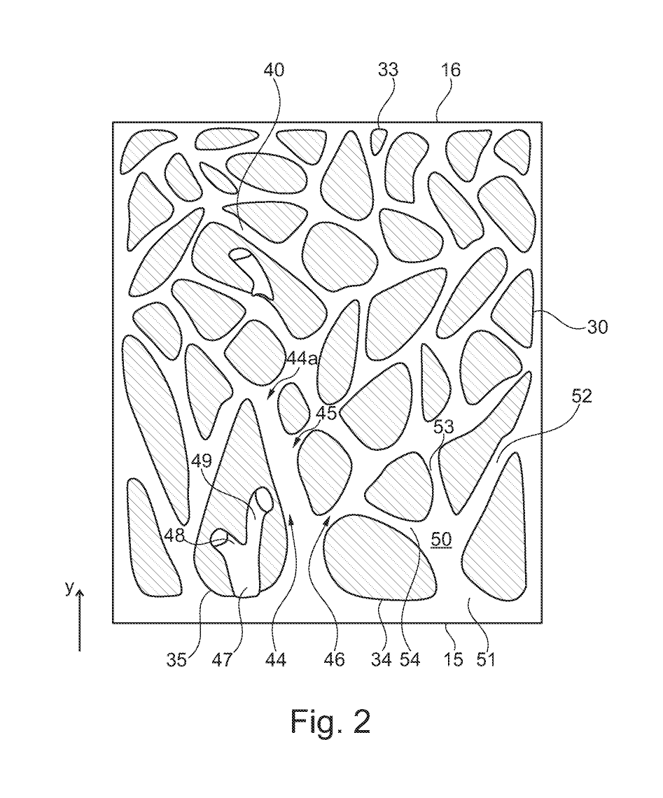

The support elements 40 can have different designs and can form different structures, of which some are described in an exemplary manner in the following. Here, reference is additionally made to the cross-sectional view of FIG. 2, which represents a section along the line A-A of FIG. 1 and thus perpendicular to the circumferential direction θ of the blade/vane of FIG. 1.

According to one design variant, the support elements form webs 41 (cf. FIG. 1) that continuously extend between the suction side 14 and pressure side 13 of the blade/vane 1. Together with the material areas 42 which adjoin the blade/vane outer skin 10, the webs 41 enclose the hollow spaces 30. However, it is to be understood that these hollow spaces 30 by no means extend continuously up to the blade/vane tip 16 in the radial direction, but that instead a plurality of hollow spaces 30 is provided in the radial direction, which are respectively delimitated in their radial expansion, as is shown in FIG. 2. Accordingly, the webs 41, too, do not extend or do not extend exclusively in the radial direction r, but extend obliquely to the radial direction r, wherein they typically have a curved spatial course at least in certain sections. The curved spatial course of the support elements 40, 41 is schematically shown in FIG. 1 by showing support elements 40′ projecting into the hollow spaces 31 in some of the hollow spaces 31, wherein the shown section exposes the cross-sectional surface 43 of these support elements 40′.

Further, it is to be understood that although the shown hollow spaces can be completely surrounded by material of the support elements 40 as well as by the material 42 that adjoins the blade/vane outer skin 10, so that closed hollow structures are present, such a structure is not mandatory. Alternatively, partially or completely hollow structures can be realized that are connected to each other and are only closed in the respective cross-sectional view (e.g., the profile sections X1, X2 of FIG. 1).

FIG. 1A, which represents a section of FIG. 1, shows five details A to E, providing a more detailed description of the asymmetrical, irregular three-dimensional grid.

The details A and B show continuous support elements that have a free spatial orientation, with all spatial angles being present. The details C and D show three-dimensional knots of the support elements, i.e., three support elements that have a free spatial orientation connect to form knots, wherein also in this case the spatial angles can be chosen freely. Detail E shows a support element that extends freely from the suction side to the pressure side. Again, all spatial angles are possible. No further knot for support elements is necessary.

FIG. 2 shows multiple exemplary spatial courses of elongated support elements. Thus, a support element 44 is shown that is configured adjacent to the blade/vane root 15 and tapers off towards its end 44a, consequently having a decreasing cross-sectional surface along its spatial course. At the same time, the support element 44 extends obliquely to the radial direction r of the blade/vane.

Further, it can be seen as a typical feature that two further support elements 45, 46 branch of laterally from the regarded support element 44.

Further, FIG. 2 shows an exemplary design variant, in which a support element is divided into two support elements in a branching area. Thus, the support element 47 that is projecting into the hollow space 35 is divided into two support elements 48, 49.

Another typical structure is a plate-like planar area 50, which is created by a plurality of support elements 51-54 uniting, or by support elements starting from it.

What is thus present in total is a cross-linked structure of the individual support elements 40, 41, 44-54, wherein the support elements are split up or united, and can form branches and plate-like areas. The cross-linked structure comprises a plurality of junctions between the support elements 40, 41, 44-54 amongst each other as well as between the support elements 40, 41, 44-54 and the blade/vane outer skin 10 (or at material areas 42 that adjoin the blade/vane outer skin 10 and form an edge there). Here, the support elements 40, 41, 44-54 extend obliquely to the radial direction of the blade/vane 1 at least in certain sections, and can be configured in a curved and at the same time rib-like manner at least in certain sections. The cross-sectional surface varies along its spatial course.

What can for example be regarded as the starting point of an elongated support element 40, 41, 44-54 is the junction or the bifurcation of a support element (cf. support elements 45, 46, 48, 49 of FIG. 2) or the beginning of the configuration of a support element adjoining the blade/vane outer skin 10 (cf. support element 44 of FIG. 2), or the beginning of the configuration of a support element adjoining a wall-like area (e.g. the support element 54 begins at the position where it leaves the plate-shaped area 50). What can for example be regarded as an endpoint of a support element is a point or an area at which the support element ends at the blade/vane outer skin 10, or at which the support element is divided into two support elements in a branching area (e.g., the support element 47 of FIG. 2 ends at the bifurcation to the support elements 48, 49), or at which a support element ends in a unifying area.

The described blade/vane internal structure 20 also results in a certain type of hollow space, which will be described in the following.

Due to the described grid structure, the individual hollow spaces differ in shape and size. At that, the hollow spaces are strongly diversified with respect to their size, wherein at least two of the hollow spaces differ from each other in the cross section in a sectional view of the blade/vane (e.g. in the profile sections X1, X2 of FIG. 1, or in the longitudinal section of FIG. 2) by at least the factor 5. For example, in FIG. 2 the hollow spaces 33 and 34 differ in the shown sectional view with respect to their cross section by at least the factor 5. What is considered the cross section here is the greatest distance between two points on the curve that is formed by the section. The differences in size can be configured to be even greater, wherein the regarded cross sections can differ by a factor of larger than the factor 5, e.g. by the factor 10 or 20.

Further, it can be seen that the hollow spaces 30 to 35 have a smooth and convex limiting curve in the respectively regarded sectional view.

The mentioned characteristics of the hollow spaces can be realized in a sectional view perpendicular to the radial extension direction (e.g. as in the sectional views X1, X2 of FIG. 1) as well as in a sectional view perpendicular to the circumferential direction of the blade/vane (correspondingly to the sectional view of FIG. 2).

What can further be seen in FIG. 1 is that the share of the hollow spaces in the total volume of the blade/vane internal structure 20 increases in the radial direction outward. Thus, the blade/vane 1 always comprises less blade/vane material towards the outside and is accordingly configured to become increasingly light in the radial direction. This can particularly be seen by comparing the profile sections X1, X2 of FIG. 1.

If the mean hollow space density is determined in the section of FIG. 2, what results is a value of between 65 and 80%. In the radially outer area (at the bottom of FIG. 2) a higher hollow space density is present, in the radially inner area (at the top of FIG. 2) a lower hollow space density is present. Thus, a mean density of 65 to 80% is achieved for a section along the curved central axis of blade/vane 1.

What can also be seen is that in most cases between 3 and 5 support elements 40, 41, 44 to 54 converge in the branching areas.

A further means for characterizing the structure of the support elements 40, 41, 44 to 54 is the number of the branching areas in different directions of the blade/vane 1. Thus, between 0.1 and 5, in particular 0.1 to 3, quite particularly between 0.1 and 0.5 connection areas may be arranged per mm running length of the support elements (40, 41, 44-57).

In the area of the greatest thickness of the blade/vane 1, between 2 and 20 connection areas can be passed on the shortest path via the support elements 40, 41, 44 to 54. In another direction, namely from the leading edge to the trailing edge, two to 50 connection areas can be passed on the shortest path along the support elements 40, 41, 44 to 54.

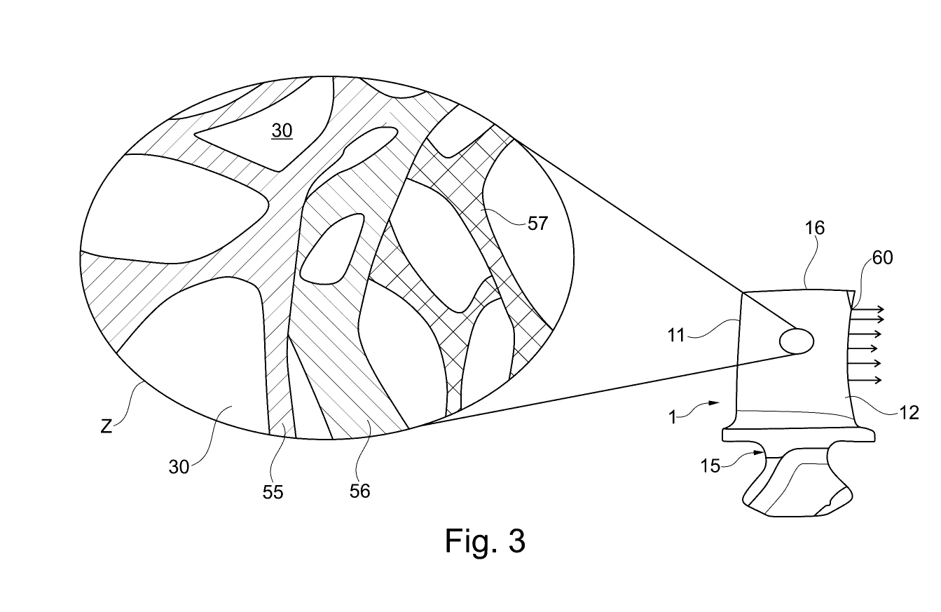

FIG. 3 shows another exemplary embodiment of a blade/vane 1 that has a blade/vane internal structure with a plurality of elongated support elements. Just like the blade/vane of FIGS. 1 and 2, the blade/vane 1 has a leading edge 11, a trailing edge 12, a pressure side, a suction side, a blade/vane root 15, and a blade/vane tip 16. In the exemplary embodiment of FIG. 3, the blade/vane root 15 is shown as a structural part and not only in a schematic manner like in FIG. 1.

The enlarged rendering Z shows the blade/vane internal structure by way of example in a three-dimensional rendering, wherein three different planes of the space are represented by three different hatchings. A plurality of elongated support elements 55, 56, 57 is shown, having varying cross-sectional surfaces along their spatial courses and extending obliquely to the radial direction of the blade/vane 1 at least in certain sections, wherein the support elements 55, 56, 57 form bifurcations, junctions and merging areas, and in total form a three-dimensional asymmetrical grid. The areas between the support elements 55, 56, 57 are again configured as hollow spaces 30.

FIG. 3 clarifies the three-dimensional, spatially curved spatial course of the support elements, which in FIGS. 1 and 2 are respectively shown only in cross-sectional views.

Moreover, another optional aspect is pointed out by reference to FIG. 3. Thus, it can be provided that the blade/vane internal structure forms channels that are suited for the purpose of transporting cooling air. In the described blade/vane internal structure, such channels can for example be provided through hollow spaces that are configured in an elongated manner and/or through multiple hollow spaces that are connected to each other. In this way, it is possible to effectively cool the blade/vanes. The cooling air can for example be supplied via the blade/vane root 15. Here, it can be provided that one or multiple of the hollow spaces form cooling openings in the blade/vane outer skin. Such cooling openings can for example be configured in the area of the blade/vane trailing edge 12. Exemplary cooling openings 60 are schematically shown in FIG. 3.

It is to be understood that the cooling of thin blade/vanes, as they are used particularly in compressors, is also facilitated thanks to the blade/vane internal structure.

A blade/vane comprising internal space structuring can be manufactured by means of a generative manufacturing method, for example by means of a laser melting method (laser deposition) or 3D printing. For example, the following method can be used for manufacture.

First, a solid material model of the blade/vane is created. This solid material model is cross-linked with a sufficient resolution within the meaning of a finite elements method. Subsequently, an iterative removal of material areas of the solid material model based on a finite elements method is carried out. In the course of each iteration, at least one such material area of the solid material model is removed which would be subject to a minor load during operation of the blade/vane in a turbomachine.

According to one embodiment, two iteration processes are carried out for this purpose. As part of the first iteration process, at first the starting conditions are determined. Based on the determined starting conditions, a second iteration process is performed. In its course, material areas of any shape and size are removed at different positions in the solid material model according to the starting conditions. Subsequently, the loads in the modified model (i.e., the model following the removal of material areas) are determined during operation of the blade/vane. They can also be determined by means of simulations. After that, a comparison of the resulting loads with valid acceptance criteria is carried out. If the acceptance criteria are met, another removal of material is performed and a new iteration is started as part of the second iteration process by using the modified model. If the acceptance criteria are not met, the model of the last iteration that met these criteria is used, and the second iteration process is terminated.

Subsequently, a modification of the starting conditions or a specification of new starting conditions for another second iteration process is carried out as part of the first iteration process. Then, a comparison of the results of at least two different second iteration processes is carried out. This first iteration process is terminated when pre-determined conditions are obtained and/or no further enhancement of the results with respect to the acceptance criteria takes place. Then, a 3D blueprint is created for the model that is provided at the end of the second iteration process. Subsequently, the manufacture of the blade/vane is carried out based on the created 3D blueprint by means of a generative manufacturing method.

The described method leads to the provision of an internal structure of the support elements of the blade/vane that is adjusted to the stress requirements. At that, the shape and size of the cross section of the support elements can be selected freely so as to be suitable for the occurring loads. What is provided is a construction that is completely adjusted to the stress requirements, wherein the areas that receive minor loads are subtracted out or removed from the solid material model in an interative manner by means of the applied finite elements method.

The provided permeable blade/vane internal structure can be used for cooling the blade/vane, wherein it can also be provided that cooling openings are realized in the blade/vane surface.

With respect to its design, the invention is not limited to the exemplary embodiments shown above, which are meant to be examples only. Thus, for example the shape, the number and the dimensioning of the support elements and the hollow spaces is to be understood merely as an example in the shown Figures.

Further, it is to be understood that the features of the individual described exemplary embodiments of the invention can be combined with each other to form different combinations.

As far as areas are defined, they comprise all values within these areas as well as all partial areas falling within an area.

A blade/vane, in particular according to one of the embodiments described herein, can be manufactured according to the claimed method.

1. A blade/vane for a turbomachine, comprising a
blade/vane outer skin and a blade/vane internal structure,
wherein the blade/vane internal structure has a plurality of elongated support elements extend obliquely to the radial direction of the blade/vane at least in certain sections, wherein the support elements are connected to each other and/or to the blade/vane outer skin, and the areas between the support elements are configured as hollow spaces, wherein the support elements form an irregular and asymmetrical three-dimensional grid.

2. The blade/vane according to claim 1, wherein the support elements have a cross-sectional surface that varies partially or completely along its spatial course.

3. The blade/vane according to claim 1, wherein at least some of the support elements have a curved spatial course; the support elements are configured in a rib-like manner at least in certain sections and/or the support elements at least in certain sections form at least one web that extends between the suction side and the pressure side of the blade/vane.

4. The blade/vane according to claim 1, wherein at least two of the support elements converge in a branching area to form a support element and/or that at least one support element is divided into two support elements in a branching area, in particular that between 3 and 100, in particular between 3 and 50, quite particularly between 3 and 10 support elements converge in a branching area, further in particular that between 0.1 and 5, in particular 0.1 to 3, quite particularly between 0.1 to 0.5 connection areas are arranged along the support elements per mm running length of the support elements.

5. The blade/vane according to claim 1, wherein the running direction of the support elements is measured as the shortest path from the leading edge of the blade/vane to the trailing edge of the blade/vane, or as the shortest path from the suction side to the pressure side of the blade/vane.

6. The blade/vane according to claim 1, wherein the mean hollow space share in the blade/vane internal structure is between 65 and 80%, in particular between 65 and 75%, quite particularly 70%.

7. The blade/vane according to claim 1, wherein multiple of the support elements are united at least in certain sections to form planar wall areas, in particular that between 3 and 100, in particular 3 and 50, quite particularly 3 and 10 support elements are united at least in certain sections to form planar wall areas.

8. The blade/vane according to claim 1, wherein the support elements define a plurality of hollow spaces, wherein the hollow spaces have different shapes and sizes, with the hollow spaces in particular having different sizes in such a manner that at least two cross sections of the hollow spaces differ by at least the factor 5 in at least one sectional view of the blade/vane, in particular that at least two of the hollow spaces differ with respect to the cross section by at least the factor 10, by at least the factor 20, or by at least the factor 50, and/or that at least one of the hollow spaces is delimited by a smooth and convex limiting curve in the regarded sectional view, and/or that the hollow spaces have the mentioned cross section of different sizes in a sectional view perpendicular to the radial extension direction of the blade/vane and/or in a sectional view perpendicular to the axial extension direction of the blade/vane and/or in a sectional view perpendicular to the circumferential direction of the blade/vane, and/or that the share of the hollow spaces in the total volume of the blade/vane internal structure increases in the radial direction outwards.

9. The blade/vane according to claim 1, wherein there are no two support elements of the blade/vane that have an identical three-dimensional shape.

10. The blade/vane according to claim 1, wherein at least some of the hollow spaces are configured in an elongated manner and are suited for the purpose of transporting cooling air, and/or in that multiple hollow spaces are connected to each other and in total are suited for transporting cooling air, in particular that one or multiple of the hollow spaces form cooling openings in the blade/vane outer skin.

11. The blade/vane according to claim 1, wherein the blade/vane internal structure is free of support elements that extend tangentially with respect to the blade/vane outer skin and/or steadily across the entire blade/vane outer skin, and/or that at least some of the support elements penetrate each other.

12. A turbofan engine with a plurality of blade/vanes according to claim 1.

13. A method for manufacturing a blade/vane according to claim 1, comprising the following steps:
creating a solid material model of the blade/vane,
iteratively removing material areas of the solid material model based on a finite elements method, wherein, in the course of each iteration, at least one such material area of the solid material model is removed that would be subject to a minor load during operation of the blade/vane in a turbomachine, wherein the iterative method is carried out until a defined condition is obtained,
creating a 3D blueprint of the model that has been provided by the iterative method by the time the defined condition has been obtained, and
manufacturing the blade/vane based on the created 3D blueprint by means of a generative manufacturing method.

14. The method according to claim 13, wherein material areas that are subject to minor loads are removed in the course of each iteration.

15. The method according to claim 13, wherein
subsequently to the creation of a solid material model, a cross-linkage of the solid material model with a defined resolution is provided,
starting conditions are specified as part of a first iteration process,
as part of a second iteration process,
material areas of any shape and size are removed at different positions in the solid material model according to the starting conditions,
loads of the modified model are determined during operation,
a comparison of the resulting loads with valid acceptance criteria is carried out,
if the acceptance criteria are met, a further removal of material is carried out and a new iteration using the modified model is started,
if the acceptance criteria are not met, the model of the last iteration that met these criteria is used and the second iteration process is terminated,
a modification or specification of new starting conditions for a renewed second iteration process is performed as part of the first iteration process,
a comparison of the results of at least two different second iteration processes is carried out,
the first iteration process is terminated if pre-defined conditions are reached and/or no further enhancement of the results with respect to the acceptance criteria takes place, and
a 3D blueprint is created for the model that is provided at the end of the second iteration process.
